(19) United States
(12) Patent Application Publication
(10) Pub. No.: US 2004/0114899 A1
(43) Pub. Date: Jun. 17, 2004

(54) Planar, integrated, optical, air-clad waveguide and method of producing same

(76) Inventor: Kent Erick Mattsson, Virum (DK)

Correspondence Address: JACOBSON HOLMAN PLLC, 400 SEVENTH STREET N.W., SUITE 600, WASHINGTON, DC, 20004, US

(21) Appl. No.: 10/203,616

(22) PCT Filed: Feb. 15, 2001
(86) PCT No.: PCT/DK01/00105

(30) Foreign Application Priority Data
Feb. 16, 2000 (DK) PA 2000 00239

(51) Int. Cl. G02B 6/10

(52) U.S. Cl. 385/129

(57) ABSTRACT

Planar, integrated, optical air-clad waveguide and method for the manufacture hereof. The air-clad waveguide consists of a thick central part (20) which functions as a wave-guiding core, and thin parts (21, 22) which are connected hereto and serve to support the core and also select which wave types are to be guided through the central part. The thin part is connected to a planar substrate (23). In a preferred embodiment, the air-clad waveguide is formed from the substrate by a combination of the removal of surplus material (24) and thermal oxidation (25). With the invention an add/drop-multiplexer is disclosed, which makes it possible to remove or add one or more signals with well-defined centre wavelength. With the invention a non-linear element for the visible wavelengths as well as wavelengths in the infrared range, and a method for the tuning of filters are also disclosed.

The invention concerns a planar, integrated, optical air-clad waveguide for the transmission of electromagnetic waves of a predetermined wavelength λ, the waveguide defining an optical axis.

The invention also concerns a method for the manufacture of an integrated, optical, air-clad waveguide for the transmission and filtering of electromagnetic waves.

Integrated, optical waveguide components are important in connection with the redistribution and/or filtration of electromagnetic waves through fibre-optical communication networks. The material preferred for the manufacture of such integrated components is glass, in that this material is directly compatible with the glass fibre. Here, one of the most promising systems for the manufacture of passive, optical components consists of glass-on-silicon structures, where the silicon substrate with V- or U-shaped alignment channels provide the possibility of achieving controlled coupling between fibre and integrated waveguide. A number of alternatives to glass-on-silicon are in existence. Use is thus made of ion exchange for the manufacture of waveguides in glass, and diverse polymeric materials for the manufacture of the cores and cladding etc.

The basic element in all integrated components is the waveguide. This consists of a core material with a refractive index, which is greater than that of the cladding material. The higher index in the core is achieved by using a material, which is different from the cladding material or through the doping of this and/or the cladding material.

One of the most important parameters in connection with the establishing of an optical waveguide is the relative refractive index Δ, which expresses the difference in refractive index between core and cladding in relation to the refractive index of the core. The choice of relative refractive index for an integrated waveguide is made on the basis of a compromise between low coupling loss for an optical standard fibre and low dispersion loss through straight and curved integrated, optical waveguides.

A good matching for a standard fibre with numerical aperture NA=0.13 is achieved by choosing a relative difference in refractive index Δ≈4·10⁻³ and a quadratic core 8 μm×8 μm, which results in a spot size which is comparable with a standard fibre. This typically gives rise to a coupling loss of approx. 0.05 dB per coupling. The spot size corresponds to 1/e² the diameter for the transversal field, which is approx. 10 μm in a standard fibre for wavelengths between 1.3 μm and 1.6 μm. Such a large spot size in an integrated waveguide means that use must be made of a thick cladding glass layer between core and substrate to prevent the field from penetrating down into the substrate. The cladding glass layer will typically be 20 μm in order to achieve acceptable dispersion loss through the waveguide (0.1 dB/cm). Moreover, a small relative difference in refractive index will mean that curvature radii for integrated waveguides will be around 30 mm.

In order to reduce the demand for thickness of the cladding glass layer, reduce curvature radii and retain an acceptable coupling loss for a standard fibre, a relative difference in refractive index of Δ≈8·10⁻³ is chosen, with a quadratic core 6 μm×6 μm. The fibre coupling losses are hereby increased to around 0.5 dB per coupling, while curvature radius is reduced to approx. 5 mm. The thickness of the cladding glass layer can hereby be reduced to approx. 12 μm for the lower and 10 μm for the upper cladding glass.

The greatest problem and technological challenge in connection with the manufacture of integrated, optical glass-on-silicon components is found in connection with the formation of the relatively thick glass layers. Here, a uniform refractive index of several types of glass over large substrates is required. To this can be added the demand concerning uniform etching of the core over large substrates. The result is that the production of such components is relatively expensive, not least because even relatively simple functions in plane structures, as a consequence of the relatively large curvature radii, demand large areas on the substrate in order to be realised. This means that only few components per substrate can be realised.

From the fibre technology it is known to be possible to produce air cladding waveguides. Here, the core consists e.g. of a glass rod supported by thin glass holders, while the cladding consists of vacuum or gas. The core and the support are inserted in a thick glass cladding, which surrounds this in order to protect the frail structure. Use is made of the same type of glass for all parts of the fibre, and for this reason this is known as a single-material waveguide. The single-material fibre is produced by a drawing process, which means that it is not possible to produce functional components by means of lithographic processes.

It is characteristic of integrated waveguides that they are normally produced on a solid substrate. Here, the core can be defined by diffusion or through the deposition of at least one cladding layer and one core layer, in which the waveguide core is defined by a topological etching through lithographic processes. As a rule, the core will subsequently be protected by a further cladding layer which displays a refractive index lower than the core.

From an article by Little, B. E. et al: Vertically Coupled Glass Microring Resonator Channel Dropping Filters, IEEE Photonics Technology Letters, February 1999, page 215-217, an integrated, optical resonator is known, which is used as a dropping filter, where the resonator is built up as an air-clad waveguide which is vertically coupled to waveguides buried in an underlying substrate. The resonator waveguide is of the type where the waveguide is configured as a rib-formed structure, which rests on an underlying substrate, and where the remaining sides of the rib are surrounded by an air cladding.

U.S. Pat. No. 5,579,424 discloses a planar, integrated, optical waveguide of the conventional encapsulated type, which is mounted on a substrate. The substrate is provided with a depression for the securing of an optical fibre, which can hereby be connected with the planar waveguide. Both depressions are formed by etching the carrying surface.

U.S. Pat. No. 3,589,794 discloses different optical waveguides for different uses, among other things as channel dropping filters. It is also disclosed that tuning of the resonant frequency of the filters can take place by bringing a transparent dielectric material close to the resonant structure, and by moving the dielectric material either vertically or horizontally in relation to the waveguides.

None of the above-mentioned publications disclose integrated, optical waveguides, which are built up as air-clad waveguides, where the central core is connected via thin membrane-formed parts to a planar substrate.

Finally, from the specification of Danish application no. PA 1999 01580, not publicised on the submission date of the present application, a waveguide is known, which is produced from a silicon substrate. Here, a waveguide is formed in the substrate by removing a part of this, doping other parts of this and applying additional material layers, so that a waveguide with core and cladding layers is formed.

The object of the invention is to establish an integrated, optical waveguide of a material on a thin membrane freed from the substrate material.

As disclosed in claim 1, the object of the invention is achieved by the air-clad waveguide being configured with a cross-section at right angles to said optical axis, the waveguide consisting of a relatively thick central part and an associated thin membrane-formed part which extends in a direction away from the central part, and where the thin membrane-formed part is connected to a plane substrate at a distance which is at least one order of magnitude greater than the wavelength λ of the electromagnetic waves.

The advantage of this is that a waveguide can thus be formed in a single material surrounded by glass, a vacuum or liquid, where small variations in the refractive index of the material are of no essential significance regarding the effect of the waveguide. Moreover, the use of thick cladding layers is hereby avoided, as the thin part extends for a distance, which is at least a size greater than the wavelength of the electromagnetic wave.

With regard to the possibility of producing the air-clad waveguide according to claim 1, it is an advantage, as disclosed in claim 2, if this displays a preferably rectangular cross-section, and where the thin part is connected to the central part along one side.

As disclosed in claim 3, it is an advantage if the relatively thick central part of the air-clad waveguide, preferably with rectangular cross-section, has a width w greater than 4 μm and height h greater than 4 μm, and where the thin part has a thickness t less than or equal to h/2, when non-linear responses of the waveguide shall be suppressed at single-mode operation.

It is a further advantage if, as disclosed in claim 4, the thick and thin parts of the air-clad waveguide are formed of the substrate material by removal of excess material. Hereby no cladding layer is required for the isolation of the core from the substrate. Moreover, the use of the substrate material will be a source for very well controlled and easily reproducible material.

In connection with the production of the air-clad waveguide, unevenly etched side walls of the central part will result in increased transmission losses. This can be reduced by forming the central part of the air-clad waveguide of doped glass, as disclosed in claim 5. The use of doped glass makes it possible, after this has been etched, to effect a heat treatment, which liquefies the glass and hereby evens out roughness on the sidewalls. The thin parts, which support the central part, can with advantage be formed from the substrate by removing surplus material, so that their shape is retained during the heat treatment. A further advantage of forming the central part of doped glass is that control is hereby achieved over the effective refractive index of a given wave type through both the shape of the central part as well as its refractive index. This especially in connection with achieving control over that part of the wave, which fluctuates parallel with the thin parts. A further advantage is that it is possible to obtain a refractive index of the central part, which matches the refractive index in the core of a standard optical fibre.

With regard to uses of the air-clad waveguide for the transmission and filtering of electromagnetic waves, it is an advantage, as disclosed in claim 6, that this supports at least one wave type for the electromagnetic waves.

As disclosed in claim 7, it will also be an advantage that at least one optical fibre is connected to the air-clad waveguide, which fibre is secured to a depression formed in the plane substrate.

In order to reduce the loss of optical energy at the transition between optical fibre and air-lad waveguide, as disclosed in claim 8 it is an advantage if at least one of the ends of the central part of the air-clad waveguide is terminated in a narrowing-down, whereby the spot size of the field in the air-clad waveguide is increased so that this will approximate the spot size in the fibre.

In connection with applications which demand integrated waveguides with combinations of different sections with small and very large relative differences in refractive index Δ, respectively, as disclosed in claim 9 it is an advantage that at least one air-clad waveguide is embedded in a cavity formed in the core or the cladding of an integrated, optical waveguide. This cavity is formed in the substrate with a core for the transmission of electromagnetic waves, where the core, which is placed between an upper and a lower cladding layer, displays a greater refractive index than that of the upper and the lower cladding layer. A combination of the relatively small Δ of the integrated, optical waveguide with the large Δ from the air-clad waveguide is hereby achieved.

As disclosed in claim 10, in order to be able to couple light from the air-clad waveguide to the integrated, optical waveguide formed on the substrate, it is an advantage that the central part of the air-clad waveguide is connected directly to the core of the integrated, optical waveguide.

As disclosed in claim 11, with applications in connection with fibre-optic networks, it is a further advantage that at least one optical fibre, which is secured in a depression formed in the plane substrate, is connected to the integrated, optical waveguide according to claim 9.

With regard to the choice of production technology, as disclosed in claim 12 it is an advantage if the core and cladding layer of the integrated, optical waveguide according to claim 9 are formed in pure glass and/or doped glass, and the plane substrate is formed of silicon.

It is hereby possible to use well-established processes for silicon substrates known from the production of integrated, electrical components for the manufacture of the integrated, optical components.

This provides the further possibility that the central part of the air-clad waveguide, according to claim 13, with advantage can be formed in doped glass, silicon nitride or a polymeric material. This type of material is known in connection with the passivation and packaging of electrical circuits.

As disclosed in claim 14, with regard to the mechanical effect of the air-clad waveguide from the integrated, optical waveguide, it is an advantage if the integrated, optical waveguide is embedded in the substrate, so that the optical axis for the core of the integrated, optical waveguide and the optical axis through the central part of the air-clad waveguide are coincident.

It is a further advantage, as disclosed in claim 15, if the upper cladding layer is limited to cover only the embedded part of the integrated, optical waveguide. It is hereby avoided that stress from the thick glass layers, which constitute the integrated, optical waveguide, influences the air-clad waveguide. The known compressive stress in the glass-on-silicon, which among other things gives rise to double infraction, and which arises due to the difference in thermal expansion of the silicon substrate and the glass structure, is hereby reduced.

In connection with the production of functional air-clad waveguides, as disclosed in claim 16 these can with advantage be formed by several central parts being placed on the same thin part.

As disclosed in claim 17, a directional coupling can be formed by placing the central part of a first air-clad waveguide at the side of the central part of a second air-clad waveguide at a distance, which allows coupling of electromagnetic waves through these parts.

A resonant structure for use in the selection of individual optical frequencies can be formed as disclosed in claim 18 by the respective ends of the central part of the air-clad waveguide being joined together, so that the central part constitutes a closed circuit. The closed circuit can generally have a random shape.

As disclosed in claim 19, power division of the optical signal can with advantage be brought about by at least one end of the central part of the air-clad waveguide being divided in the longitudinal direction into at least two branches.

This power division can be used to provide a reflecting termination of the air-clad waveguide by, as disclosed in claim 20, at least two branches being joined together at their respective ends.

As disclosed in claim 21, tuning of the effective refractive index of the air-clad waveguide can be achieved by placing a transparent dielectric material in the proximity of the central part of the air-clad waveguide. A tuning can thus be effected by changing the distance between the transparent dielectric material and the waveguide, or by changing the area, which is covered by the transparent dielectric material, for a retained distance.

As mentioned, the invention also concerns a method. This method is described in more detail in claim 22, and is characterised in that it comprises the following steps:

a) Silicon is selected as substrate material,

b) a mask is applied to the front of the substrate material, and the relatively thick central part of the air-clad waveguide is formed,

c) an etch-stop layer is formed in the substrate,

d) a film of silicon nitride is applied to the substrate,

e) the front of the substrate is provided with a further mask, and holes are opened by etching,

f) a mask is applied to the rear of the substrate, and holes are opened by etching,

g) the substrate is etched by an anisotropic etch, whereby a part of the material under that part of the air-clad waveguide which supports the relatively thick central part, is removed,

h) the silicon nitride layer is removed from the front and the rear,

i) the substrate is exposed to a thermal annealing followed by a thermal oxidation,

j) a drop of glue is applied to the depressions in the front of the substrate, after which the fibres are mounted individually or in groups, so that

k) the fibres are moistened with glue and mounted in the depressions, where fine adjustment of their positions in relation to the respective air-clad waveguides is carried out by sending electromagnetic waves through the respective fibres and optimising the signal transmitted by moving the fibres in the plane at right-angles to the longitudinal directions of the fibres,

l) when an optimum position of the fibre has been found, this is secured while the glue hardens.

In step b) of the method, the relatively thick central part of the air-clad waveguide, as disclosed in claim 23, can with advantage be formed by reactive ion etching of the substrate in a mixture of SF₆ and O₂.

As disclosed in claim 24, a non-linear waveguide element can be established in an air-clad waveguide by forming the relatively thick central part with a preferably rectangular cross-section with a width w less than 4 μm and height h less than 4 μm, and where the thin part has a thickness t less than or equal to h/2. The light is hereby led through the central part of the air-clad waveguide with a relatively small spot size of the field, and with high non-linear responses as a consequence.

The air-clad waveguide can with advantage be formed by means of an etch-stop layer defined by diffusion of boron in through holes in an applied silicon nitride mask by a high-temperature process, as disclosed in claim 25. The choice of whether the air-clad waveguide shall be formed in silicon or silicon dioxide can first be made in step i) of the method. If it is decided here to carry out a full thermal oxidation of the substrate after the thermal annealing, an air-clad waveguide consisting of silicon dioxide will be produced.

The above is expedient if an air-clad waveguide consisting of a relatively thick silicon dioxide or silicon is desired to be produced. An air-clad waveguide consisting of relatively thin silicon dioxide can with advantage be produced, as disclosed in claim 26, by forming the etch-stop layer in step c) of the method by a thermal oxidation of silicon in an oxygenous or hydrous atmosphere. The annealing and thermal oxidisation in step i) of the method can hereby be reduced to an absolute minimum.

As disclosed in claim 27, if it desired to produce an air-clad waveguide in silicon, this can be achieved by subjecting the substrate to a thermal annealing followed by a thermal oxidation between the steps h) and j).

As disclosed in claim 28, with regard to later durability of the air-clad waveguide, a thin silicon nitride diffusion barrier can with advantage be deposited in connection with step i) of the method. Here it must be pointed out that this film has a thickness, which has only minimal influence on the waveguide's principal function as waveguide.

In connection with the establishing of holes for alignment of optical fibres, which are established by the masks in steps e) and f) of the method and the subsequent etching in step g), as disclosed in claim 29 the mask can with advantage be formed so that it comprises patterns which will compensate for convex under-etching on the edges by the anisotropic etching of silicon.

As disclosed in claim 30, the anisotropic etching in step g) of the method can with advantage be carried out in a 28 wt % KOH in aqueous solution at 80° C.

As disclosed in claim 31, a hardening of the glue which is used for mounting the fibres in the related depressions, as disclosed in step 1) of the method, can with advantage be carried out by means of an ultraviolet radiation of the glue.

In the following, the invention will be explained in more detail with reference to both the known as well as the new structures according to the invention shown in the drawing, in that

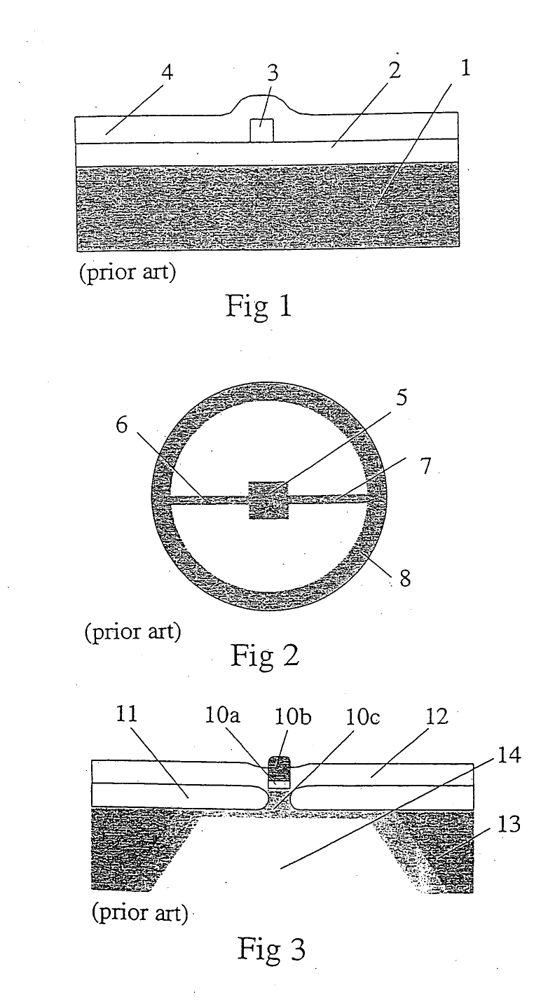

FIG. 1 shows a known, integrated waveguide seen in cross-section at right angles to the optical axis through the glass-on-silicon waveguide,

FIG. 2 shows a known single-material fibre seen in cross-section at right angles to the optical axis through the fibre,

FIG. 3 shows a waveguide, which at the time of application has not been publicised, seen in a cross-section at right angles to the optical axis through the waveguide,

FIG. 4 shows an air-dad waveguide connected to a planar substrate according to the invention,

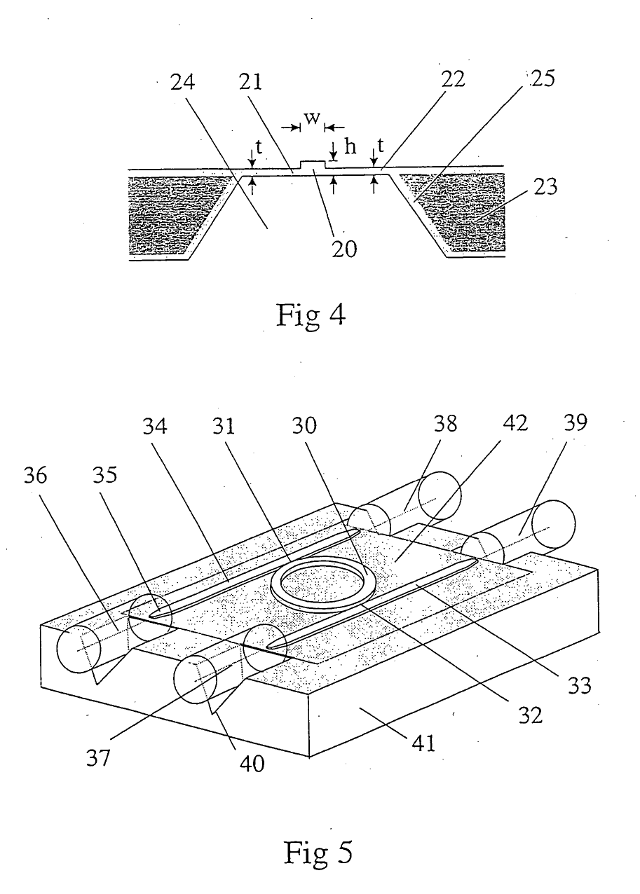

FIG. 5 shows the construction of an optical add/drop-filter based on air-clad waveguides with optical fibres coupled,

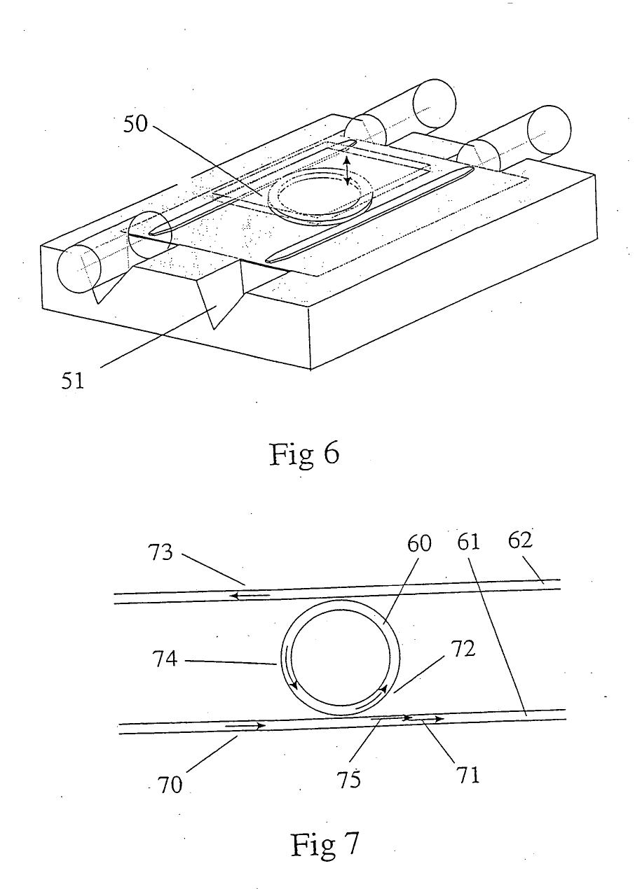

FIG. 6 shows the construction of an optical add/drop-filter in an embodiment based on air-clad waveguides with optical fibres coupled,

FIG. 7 shows the function of an optical drop-filter based on air-clad waveguides,

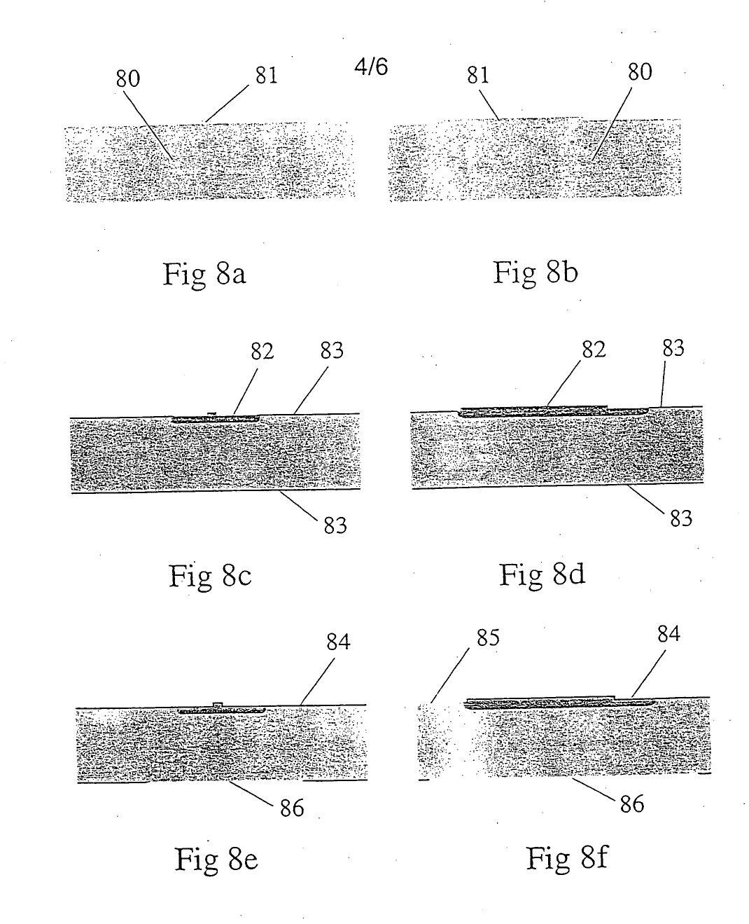

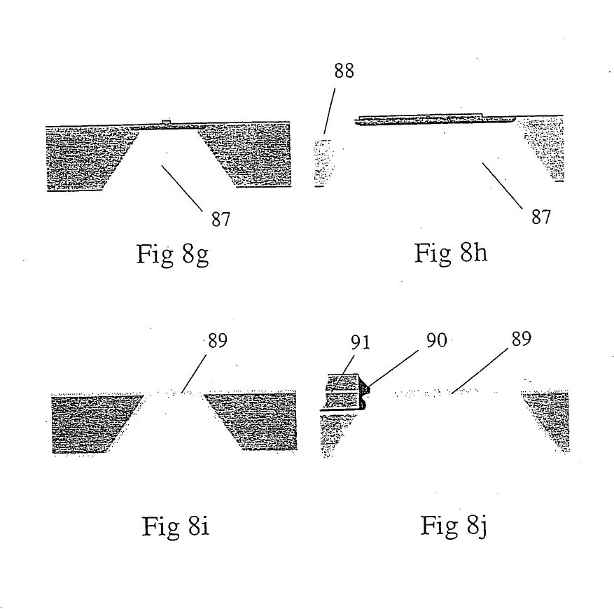

FIGS. 8a-8j show the steps involved in the method for the production of the air-clad waveguide according to the invention, in that FIGS. 8a, 8c, 8e, 8g and 8i show a cross-section at right-angles to the optical axis through the waveguide, while FIGS. 8b, 8d, 8f, 8h and 8j show a cross-section at right-angles to the plane of the substrate and along the optical axis of the air-clad waveguide, and

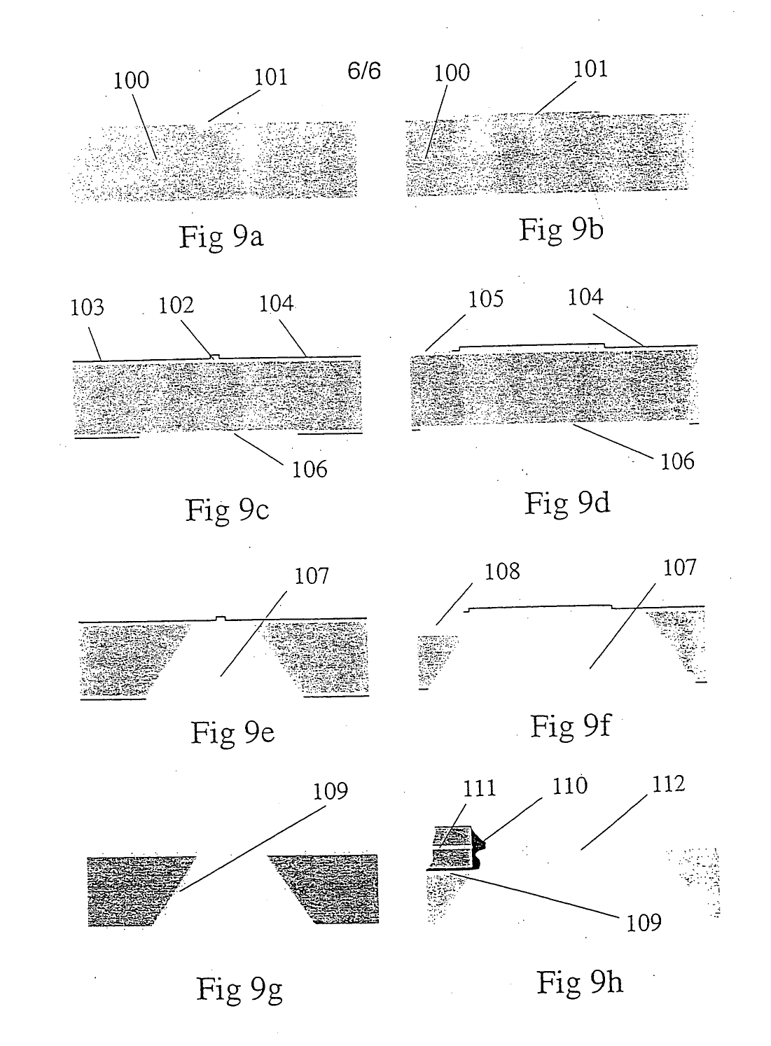

FIGS. 9a-9h show an alternative method for the production of the invention, in that FIGS. 9a, 9c, 9e and 9g show a cross-section at right-angles to the optical axis through the air-clad waveguide, while FIGS. 9b, 9d, 9f and 9h show a cross-section at right-angles to the plane of the substrate and along the optical axis of the air-clad waveguide.

In FIG. 1, which shows a known, integrated waveguide, the reference FIG. 1 indicates a substrate material, and reference FIG. 2 indicates a first lower cladding layer. A waveguide core is indicated at 3, and an upper cladding layer is indicated at 4. In this connection, attention is drawn to the fact that such integrated waveguides do not make use of the substrate material for anything other than as a support for the structure, and an essential function of the lower cladding layer 2 is to isolate the field in the waveguide core from the substrate.

In FIG. 2 there is shown an air-clad fibre, the core of which is indicated at 5, while thin structures which support the core are shown at 6 and 7. These secure the core to the outer cladding of the fibre as shown at 8. All parts of this fibre are made of the same material.

In FIG. 3 a waveguide not publicised at the time of application is shown, cf. DK patent application no. PA 1999 01580. 10a indicates a core of an integrated silicon-mesa waveguide formed in low-doped silicon surrounded by doped cladding layers 10b and 10c, and cladding layers at 11 and 12 preferably consisting of silicon dioxide and/or silicon nitride. The silicon-mesa waveguide is formed from a silicon substrate 13 by removing surplus material 14.

In FIG. 4 a single-material waveguide is seen, which consists of a core 20 and thin structures 21,22, which support the core. These secure the core to a plane substrate 23. The core 20 and the thin supporting structures 21 and 22 are formed from a silicon substrate by removing surplus material 24 and, in a preferred embodiment, by an oxidation of this 25. The thickness of the thin parts is indicated with t, while h indicates the height of the central part and w the width of the central part.

FIG. 5 shows the construction of an optical add/drop-filter based on air-clad waveguides and with optical fibres coupled. At 30 a resonant structure is indicated, which structure is formed in the central part of an air-clad waveguide, so that this constitutes a closed circuit. Directional couplers are indicated at 31 and 32. These consist of two central parts of air-clad waveguides, which are placed at the side of each other at a distance, which permits coupling of electromagnetic waves between them. Straight parts of these air-clad waveguides are indicated at 33 and 34. The straight air-clad waveguides are terminated in narrowed-down portions as shown at 35 to adjust the electromagnetic field in the air-clad waveguide to the field in the optical fibre indicated at 36. Corresponding fibres are indicated at 37, 38 and 39. The fibres are secured to the substrate via depressions in the substrate as shown at 40. These are formed in the substrate material 41 at the same time that the area 42 under the air-clad waveguides is removed.

In FIG. 6, the reference FIG. 50 indicates a transparent dielectric material which, when it is brought into the proximity of the air-clad waveguide, can be used to tune the centre frequency for the resonant structure. The one fibre is removed at 51 to show how the depression in which the fibre is to be connected is configured.

FIG. 7 shows the function of an optical drop-filter. Here, 60 indicates a resonant ring structure configured in the central part of an air-clad waveguide, while 61 and 62 indicate straight, central parts of air-clad waveguides. The electromagnetic propagation through the filter is indicated by the arrows 70 to 75. The propagation and the mode of operation are explained in more detail in connection with example 3.

In the following, it is explained step by step how a single-material waveguide according to the invention is produced.

Silicon is selected as substrate material, which is indicated at 80 in FIG. 8a and FIG. 8b. A mask is deposited on the front of the substrate, and the relatively thick central part of the single material waveguide is formed at 81. In the substrate an etch-stop layer, indicated at 82 in FIG. 8c and FIG. 8d, is formed. This etch-stop layer is formed by applying a silicon nitride film 83 on the front and the rear of the substrate, applying a mask on the front of the substrate and opening holes in the silicon nitride film. Hereafter, boron is diffused into the silicon substrate by a high-temperature diffusion process, after which an etch-stop layer is formed. A further film of silicon nitride 84 is applied to the substrate, and a further mask is applied to the front of the substrate, in which holes are opened by etching 85. A mask is applied to the rear of the substrate, and holes are opened by etching 86. The substrate is etched anisotropically from both the front and the rear. A part of the material 87 under that part of the air-clad waveguide, which supports the relatively thick central part, is hereby removed from the rear, and from the front the depressions 8& are formed, in which the fibres can be secured. The silicon nitride layer is removed from the front and the rear, after which the substrate is subjected to a thermal annealing for the gassing-out of boron from the etch-stop layer. This is followed by a thermal oxidation of the structure when the air-clad waveguide is made of SiO₂, while this is omitted for an air-clad waveguide made of Si. In FIGS. 8i and 8j an air-clad waveguide 89 produced by thermal oxidation is shown. For the mounting of the fibres, which are mounted singly or in groups, a drop of glue is applied to the depressions in the front of the substrate, after which the fibres are moistened with glue and mounted in the depressions. The glue is indicated at 90, while 91 indicates a standard fibre. The positions of the fibres in relation to the respective air-clad waveguides are found by fine adjustment. When the position has been found, this is maintained while the glue hardens.

An alternative serial method for producing the air-clad waveguide is shown in FIGS. 9a-9h. Here, silicon is selected as substrate material, which is indicated at 100 in FIGS. 9a and 9b. A mask is deposited on the front of the substrate, and the relatively thick central part of the single-material waveguide is formed at 101. An etch-stop layer is formed in the substrate by a thermal oxidation of the central part indicated at 102 and the substrate indicated at 103, after which a silicon nitride film 104 is applied on the front and rear of the substrate. A mask is applied to the front of the substrate, and holes are opened in the silicon nitride film by etching 105. A mask is applied to the rear of the substrate, and holes are opened by etching 106. The substrate is etched anisotropically from both the front and the rear. A part of the material under that part of the air-clad waveguide, which supports the relatively thick central part 107, is hereby removed from the rear, and from the front the depressions are formed, in which fibres can be secured 108. The silicon nitride layer is removed from the front and the rear, after which the substrate is subjected to a thermal annealing and a thermal oxidation of the structure 109. For the mounting of the fibres, which are mounted singly or in groups, a drop of glue is applied to the depressions in the front of the substrate, after which the fibres are moistened with glue and mounted in the depressions. The glue is indicated at 110, while 111 indicates the optical standard fibre. The positions of the fibres in relation to the respective air-clad waveguides 112 are found by fine adjustment. When the position has been found, this is maintained while the glue hardens.

The function of an air-clad waveguide is as follows:

It is known from single-material fibres that an electromagnetic wave will perceive the relatively thick central part of the waveguide as an area with relatively greater effective index than the surrounding areas. One way of describing the function of an air-clad waveguide made of one material is to describe the wave guiding in the two different parts of which the waveguide consists. The single-material waveguide in a preferred embodiment will thus consist of a rectangular central part, which is connected along the one side to a relatively thin part. Here, the relatively thin part consists of a symmetrical film waveguide, where the film consists of a solid material, while its surroundings consist of gas, vacuum or liquid. In all cases there is an essential difference in the refractive index between the solid material and the surroundings. The number of wave types and their effective indices is given as a function of the thickness of the relatively thin part, and the difference in refractive index between this and the surrounding medium.

The central, rectangular part of the air-clad waveguide with given width and height similarly supports a number of wave types. As a consequence of the greater thickness of this material compared with the relatively thinner part, in this part there will be a number of wave types which display an effective refractive index which is greater than wave types in the film waveguide. These wave types will be able to propagate in the central part of the waveguide without coupling to the wave types in the film waveguide. This is contrary to wave types, which display effective refractive indices, which are identical to corresponding wave types in the film waveguide. Here, the power will be coupled to the film waveguide.

By adjusting the size of the central part and the thickness of the film waveguide, it is thus possible to produce a waveguide, which supports only one or a small number of wave types (all with two polarisation states). If the central part of the air-clad waveguide is very small (h<1 μm and w<1 μm), the film waveguide is not required to remove higher order wave types, in that only the basic wave type will be conducted. Here, an air-clad waveguide can be produced without thin parts (t equal to zero). Mechanical support of the central part is provided by the waveguide cores connected in each end of the section, which are either the cores in an integrated waveguide or the cores of an air-clad waveguide with thicker central part and thin parts connected hereto, which at their other ends are connected to the substrate. An air-clad waveguide made of one material thus distinguishes itself from traditional waveguides in that it is primarily the geometry, which determines the number of waves, which are guided by the structure. This also applies to air-clad waveguides where the central part displays a higher refractive index than the thin parts. Also here the geometry will be the dominating factor.

In the following, the dimensioning and application of the air-clad waveguide described above will be discussed in connection with a number of examples.

### EXAMPLE 1

An air-clad waveguide made of a single material will display single-mode operation with a symmetrical core, where w=h, t/h≦0.5 and w≧4 μm. Here, w is the width and h the height of the central part of the waveguide, while t is the thickness of the relatively thin parts, as will appear from FIG. 4.

For an air-clad waveguide it applies that NA≈λ(2t) where λ is the wavelength. If a perfect matching to a standard fibre's NA=0.13 at λ=1.3 μm is desired, the thickness of the thin areas must thus be 5 μm. This gives rise to h<10 μm and w<10 μm.

### EXAMPLE 2

For an air-clad waveguide where NA is matched to that of a standard fibre, and where the size of the central part is matched to the size of the core in a standard fibre, h and w will be approx. 8 μm. The curvature radius R, which theoretically does not give rise to any substantial extra loss (<10⁻³ dB for 90° curvature), will here be: R>24/π(n/λ)²t³[1−(t/h)²−(t/w)²/(1+C)²]^{-3/2}, where C=2/πt²(w h)[1−(t/h)²]−^{-1/2} and n is the refractive index of the material. Here, use is made of n=1.5. This gives rise to a curvature radius R>5.3 mm. This can be compared with corresponding, traditional, embedded, integrated waveguides with an 8 μm×8 μm core and Δ≈4·10−3, which requires a curvature radius greater than 25 mm.

A symmetrical field in the air-clad waveguide, which gives small curvature radius and mechanically stable thin parts, is achieved by reducing the size of all parameters. A thickness of t=2 μm and width equal to height w=h=4 μm will thus give rise to a curvature radius R>188 μm. Here, there will be a coupling loss to a standard fibre of approx. 1.5 dB. This can be reduced by a narrowing-down of the central part of the waveguide, so that the wave profile matches the wave profile in the standard fibre.

### EXAMPLE 3

In connection with the establishing of transmission systems, which transmit a large number of wavelengths in the same optical fibre, there is a need for these to be able to be combined and filtered. In these wavelength-division-multiplex-(WDM)-systems, the individual channels are separated at their centre wavelengths. Such a system can be realised by resonant structures in air-clad waveguides as shown in FIG. 5 and FIG. 7. The shown add/drop multiplexer is produced by combining a resonant structure 30 and two directional couplers 31 and 32.

The function as dropping-filter, which singles out a characteristic frequency, is described with reference to FIG. 7. A number of channels with different centre wavelengths are transmitted through the same air-clad waveguide as indicated with the arrow 70 in FIG. 7. A part of this signal 71 will continue unaffected through the directional coupler, while a small part of the signal 72 will be coupled into the resonant structure. The centre wavelength, which corresponds to the resonance in the structure, will build up a field 74, which is coupled back into the transmission line as indicated at 75. Due to the nature of the directional coupler, the signal, which is coupled back into the transmission line 75, will continue only in the direction of the arrow. Here, the signal 75 out-phases the signal 71, whereby the signal with the centre wavelength corresponding to resonance in the circuit is not transmitted further. This signal is coupled out of the resonance circuit at 73 in the drop-channel. Since this structure is reciprocal, a corresponding function will apply for an add-channel, where a centre wavelength, which is in resonance with the structure, can be added to a number of channels with different centre wavelengths.

### EXAMPLE 4

In connection with the establishing of filters for use for wavelength-division-multiplexing (WDM), it is an advantage if a resonant circuit can be tuned, whereby different centre wavelengths can be selected by use of a single structure.

An example of such a structure is shown in FIG. 6. By placing a transparent dielectric material in the proximity of the resonant structure, it is possible to change that frequency at which this is resonant. Tuning of a resonant structure is achieved by changing the effective refractive index of the air-clad waveguide. By reducing the distance between the central part of the resonant structure's air-clad waveguide and the transparent material, the effective refractive index of the structure will be increased. This means that the resonant frequency of the structure is reduced. Alternatively, if the distance between the central part of the air-clad waveguide and the transparent material is maintained, tuning of the resonant frequency can be achieved by changing that part of the structure, which is covered by the transparent material. This can be achieved by moving the transparent material in the horizontal direction.

### EXAMPLE 5

In connection with the establishing of non-linear elements (both in the visible range as well as the infra-red wavelength range), it can be advantageous for use to be made of an air-clad waveguide. This can with advantage be formed with a mode area at the input matched to a standard fibre (approx. 6 μm×6 μm), which in an adiabatic transition—brought about by lithographic processes—is converted to a mode-area with a spot size less than 5 μm². The effective density of the light from the input is hereby increased by at least one magnitude through the adiabatic transition, and non-linear effects become active. The advantage of using an air-clad waveguide is that it does not require special depositions on the core in order to achieve great differences in index between core and cladding as in traditional waveguides.

The existence of air in the cladding for the structure means that it is possible to change the wavelength, at which zero dispersion is observed, in the waveguide down towards the visible spectrum where strong and fast light sources are accessible. It is possible to form the air-clad waveguide so that this displays abnormal dispersion (positive) or zero dispersion for wavelengths shorter than 1270 nm, which is not possible with a standard waveguide of doped glass.

The non-linear element can be used to create a cam of wavelengths by sending a train of 1 ps laser pulses with a repetition rate of e.g. 2.5 GHz (400 ps between two successive pulses) through the air-clad waveguide. After the passage of 2-4 cm air-clad waveguides, this pulse train will have generated a crest of wavelengths with a distance in frequency between the individual wavelengths corresponding to the repetition rate for the pulse train (2.5 GHz), symmetrically around the carrier wavelength for the pulse train. Such a crest of wavelength frequencies can be used to establish a wavelength reference for WDM systems. In this connection it will be self-phase-modulation, which is the dominating effect, but also cross-phase-modulation and four-wavelength mixing will be active.

Although the invention is explained in connection with specific examples and embodiments, there is nothing to prevent the manufacture of further embodiments within the scope of the patent claims.

This, for example, in connection with the add/drop filter shown in FIG. 7, where for the sake of clarity two parallel, straight waveguides are shown. However, the same function can be achieved by using two straight waveguides which cross each other at an angle of 90°, and where a resonant structure is placed immediately at the side of this crossing.

Air-clad waveguides according to this invention can also be used for realising band pass filters and band stopping filters, directional couplers and power dividers. These structures are created by combining a number of single components, as will appear from the independent claims.

Non-linear response of the glass material in air-clad waveguides with small core sizes (spot size less than 5 μm²) according to this invention can also be used for a number of non-linear components. Examples of such are wavelength converters with four-wavelength mixing, pulse compressors by use of the self-induced changing of the refractive index of the light, and purely optical shift function where a control wave determines the direction of a signal-carrying wave.

With the method for the manufacture of the air-clad waveguide, surplus material is removed from the rear. This can also be achieved by forming holes in the front of the substrate, so that only those parts of the substrate closest to the central part of the air-clad waveguide are removed, in that this is effected while the parts further away are retained, with a more stable structure as a consequence.

The holes formed in the front will be able to be used for establishing photonic bandwidth functions for the waveguide, this providing that the holes have dimensions corresponding to a quarter wavelength with a period (longitudinally and/or transversely to the waveguide) less than a wavelength of the light conducted in the waveguide.

1. Planar, integrated, optical air-clad waveguide for the transmission of electromagnetic waves of a predetermined wavelength λ, the waveguide defining an optical axis, characterized in that the air-clad waveguide is configured with a cross-section at right angles to said optical axis, the waveguide consisting of a relatively thick central part and an associated thin membrane-formed part which extends in a direction away from the central part, and where the thin membrane-formed part is connected to a plane substrate at a distance which is at least one order of magnitude greater than the wavelength λ of the electromagnetic waves.

2. Air-clad waveguide according to claim 1, characterized in that the central part has a mainly rectangular cross-section, and where the thin part is connected to the central part along one side.

3. Air-clad waveguide according to claim 2, characterized in that the relatively thick central part with mainly rectangular cross-section has a width greater than 4 μm and a height h greater than 4 μm, and where the thin part has a thickness which is less than or equal to h/2.

4. Air-clad waveguide according to claim 1-3, characterized in that the thick and the thin parts of the air-clad waveguide are formed from the substrate material by the removal of surplus material.

5. Air-clad waveguide according to claim 1-2, characterized in that the central part is formed in doped glass, and the thin part is formed from the substrate material by the removal of surplus material.

6. Air-clad waveguide according to claim 1-5, characterized in that the central part supports at least one wave type for the electromagnetic waves.

7. Air-clad waveguide according to claim 1-6, characterized in that at least one optical fibre, which is secured to a depression formed in the plane substrate, is connected to the air-clad waveguide.

8. Air-clad waveguide according to claim 1-7, characterized in that at least one of the ends of the central part of the air-clad waveguide is terminated in a narrowed-down part.

9. Air-clad waveguide according to claim 1-8, characterized in that at least one air-clad waveguide is embedded in a cavity formed in an integrated, optical waveguide formed in the substrate, and where the integrated, optical waveguide has a core for the transmission of electromagnetic waves, and where the core, which is placed between an upper and a lower cladding layer, displays a refractive index greater than that of the upper and lower cladding layer.

10. Air-clad waveguide according to claim 9, characterized in that the central part of the air-clad waveguide is connected directly to the core of the integrated, optical waveguide.

11. Air-clad waveguide according to claim 9-10, characterized in that at least one optical fibre, which is secured in a depression formed in the plane substrate, is connected to the integrated, optical waveguide.

12. Air-clad waveguide according to claim 9-11, characterized in that the core and cladding layer of the integrated, optical waveguide are formed in pure glass and/or doped glass, and the planar substrate is formed in silicon.

13. Air-clad waveguide according to claim 1-12, characterized in that the central part of the air-clad waveguide is formed in doped glass, silicon nitride or polymeric material.

14. Air-clad waveguide according to claim 9-13, characterized in that the integrated, optical waveguide is embedded in the substrate so that the optical axis of the core of the integrated, optical waveguide and the optical axis through the central part of the air-clad waveguide are coincident.

15. Air-clad waveguide according to claim 9-14, characterized in that the integrated, optical waveguide is embedded in the substrate, and an uppermost cladding layer is limited to cover only the embedded part of the integrated, optical waveguide.

16. Air-clad waveguide according to claim 1-15, characterized in that several central parts are placed on the same thin part.

17. Air-clad waveguide according to claim 1-16, characterized in that the central part of a first air-clad waveguide is placed at the side of the central part of a second air-clad waveguide, and at a distance which permits coupling of electromagnetic waves between these parts.

18. Air-clad waveguide according to claim 1-17, characterized in that the respective ends of the central part of the air-clad waveguide are joined together, so that the central part constitutes a closed circuit.

19. Air-clad waveguide according to claim 1-18, characterized in that at least one end of the central part of the air-clad waveguide is divided into at least two branches in the longitudinal direction.

20. Air-clad waveguide according to claim 1-19, characterized in that at least two branches are joined together at their respective ends.

21. Air-clad waveguide according to claim 1-20, characterized in that a transparent dielectric material is placed in the proximity of the central part of the air-clad waveguide.

22. Method for the manufacture of a planar, integrated, optical air-clad waveguide for the transmission of electromagnetic waves, characterized in that it comprises the following steps:
a) Silicon is selected as substrate material (80 and 100),
b) a mask is applied to the front of the substrate material, and the relatively thick central part of the air-clad waveguide is formed (81 and 101),
c) an etch-stop layer (82,83 and 102,103) is formed in the substrate,
d) a film of silicon nitride (84 and 104) is applied to the substrate,
e) the front of the substrate is provided with a further mask, and holes are opened by etching (85 and 105),
f) a mask is applied to the rear of the substrate, and holes are opened by etching (86 and 106),
g) the substrate is etched by an anisotropic etching from the base part, whereby a part of the base material under that part of the air-clad waveguide which supports the relatively thick central part is removed (87 and 107), and whereby depressions (88) are formed from the front,
h) the silicon nitride layer is removed from the front and the rear,
i) a drop of glue is applied to the depressions in the front of the substrate, after which the fibres are mounted singly or in groups, so that
j) the fibres (91 and 111) are moistened with glue (90 and 110) and mounted in the depressions, where fine adjustment of their positions in relation to the respective air-clad waveguides (89 and 112) is carried out by transmitting electromagnetic waves through the respective fibres, and optimising the transmitted signal by moving the fibres in the plane at right-angles to their longitudinal directions,
k) when an optimum position of the fibre has been found, this is secured while the glue hardens.

23. Method according to claim 22, characterized in that in step b) the relatively thick central part of the air-clad waveguide is formed by reactive ion etching of the substrate in a mixture of SF₆ and O₂.

24. Method according to claim 23, characterized in that the relatively thick central part with mainly rectangular cross-section is produced with a width w less than 4 μm and height h less than 4 μm, and where the thin part has a thickness t less than or equal to h/2.

25. Method according to claim 24, characterized in that in step c) the etch-stop layer (82) is formed by applying a silicon nitride film (83) to the front and the rear of the substrate, applying a mask to the front of the substrate and opening holes in the silicon nitride film by etching, after which boron is diffused into the silicon substrate at high temperature.

26. Method according to claim 22-25, characterized in that in step c) the etch-stop layer (102) is formed by a thermal oxidation of the silicon substrate in an oxygenous or aqueous atmosphere.

27. Method according to claim 22-26, characterized in that between steps h) and j) the substrate is subjected to a thermal annealing followed by a thermal oxidation.

28. Method according to claim 22-26, characterized in that after the thermal annealing and thermal oxidation in step i), a thin film of silicon nitride is applied to the front and rear of the substrate.

29. Method according to claim 22-28, characterized in that the mask which is applied to the rear of the substrate in step e) contains patterns which compensate for convex under-etching of edges.

30. Method according to claim 22-29, characterized in that the anisotropic etching in step f) is carried out in a 28 wt % KOH in aqueous solution.

31. Method according to claim 22-30, characterized in that in step l) the glue is hardened by radiation with ultraviolet light.
